(19) United States
(12) Patent Application Publication
(10) Pub. No.: US 2003/0147307 A1
(43) Pub. Date: Aug. 7, 2003

(54) Warning method, system and device based on transmission of acoustic signals

(76) Inventors: Marc Brussiuex, Brest (FR); Jerome Meniere, Paris (FR); Christophe Migliorini, Puteaux (FR)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/258,528

(22) PCT Filed: Apr. 24, 2001
(86) PCT No.: PCT/FR01/01247

(30) Foreign Application Priority Data
Apr. 26, 2000 (FR) 00/05301

(51) Int. Cl. G01S 15/88

(52) U.S. Cl. 367/92

(57) ABSTRACT

The invention concerns a warning system to help preventing drowning accidents. The system comprises at least a sonar (1). Each sonar (1) comprises at least a transmission antenna and a reception antenna having transmission (4) and reception (5) apertures. The sonar (1) is a parametric sonar with high spatial directive gain along said transmission (4) and/or reception (5) apertures. The angular opening of the transmission (17) and/or reception (18) lobes of said transmission and/or reception antennae is of the order of one degree or less than one degree. The system comprises a processing calculator. The sonar (1) comprises amplifier means and transmission means for amplifying and transmitting the electric signals coming from said reception antenna.

The invention concerns warning methods, systems and devices to help prevent drowning accidents. The invention is based on the use of sonar equipment transmitting acoustic signals.

The subject of the invention is the determination of some characteristics of swimmers, especially in swimming pools. These characteristics are in particular the absolute position of swimmers in the volume of water contained in the swimming pool, their extent of immobility, the quantity of air contained in their lungs. A further subject of the invention is the analysis of these characteristics and the automatic triggering of an alarm system, intended in particular for pool supervisors and swimming instructors should an abnormal situation be detected. A further subject of the invention is to send an identified swimmer audible sound messages. The subject of the invention is a low cost, acoustic detection system of reduced complexity and size, able to monitor swimmers especially in public or private swimming pools to prevent drowning accidents. The subject of the invention is this type of acoustic detection system able to be used to complement other systems, optic systems in particular.

Acoustic detection systems are known, based on the use of sonar equipment to detect swimmers in difficulty. Such sonar equipment is known to comprise a transmitting antenna which projects acoustic energy into the section of water to be monitored. A receiver captures the reflected energy, after its reflection by bodies moving within this section, and converts it into electric signals. Processing means process these signals and the information they convey. These systems generally comprise large size directive antennae, which are particularly difficult to install in a swimming pool. The installation of these systems is costly. In addition, with these systems it is not possible to accurately determine either the position of a swimmer in a swimming pool relative to other swimmers, or the quantity of air contained in the swimmer's lungs.

The invention concerns a warning system to help prevent drowning accidents. The system of the invention comprises at least one sonar. Each sonar comprises at least one transmitting antenna and one receiving antenna having transmission and reception axes. In one variant of embodiment of the invention, the transmitting and receiving antennae may in particular be in the form of a single antenna. The sonar is of parametric sonar type with high spatial directive gain along the transmission and/or reception axes. The angular aperture of the transmission and/or reception lobes of said transmitting and/or receiving antennae is in the order of one degree or less. The transmitting and receiving antennae are intended to deliver acoustic signals and to receive electric signals, or conversely. The system of the invention also comprises also comprises a processing calculator. The sonar also includes amplification means and transmission means for amplifying and transmitting, to said processing calculator, said electric signals derived from said receiving antenna. In one variant of embodiment, the sonar may also comprise amplification means and transmission means for amplifying and transmitting electric signals derived from said processing calculator to said transmitting antenna,.

Preferably, the system of the invention also comprises boxes. Each box is fixed to the wall or the bottom of the swimming pool. In this case, the transmitting and receiving antennae are mounted, inside said boxes, on swivel supports. The transmitting and reception antennae may in particular be mounted inside boxes in the shape of hollow ball joints. Each box also comprises orientating means to activate said swivel supports and to direct said transmission and/or reception axes of said transmitting and/or receiving antennae in a particular direction in space. If the boxes are in the shape of hollow ball joints, the orientation means activate the ball joints in rotation.

Also preferably, the system of the invention also comprises modulating means to modulate the acoustic energy transmitted by said sonar. The modulating means use an audible low frequency signal to modulate the acoustic energy transmitted by said sonar. In particular, the low frequency signal carries a vocal message to a swimmer.

Also preferably, the system of the invention is such that said transmission and/or reception lobes are coaxial and directed along the transmission and reception axis of said transmitting and receiving antennae. Therefore, with the orientation means, it is possible to orientate simultaneously the transmission axis and the reception axis of said transmitting and receiving antennae.

Also preferably, the system of the invention is such that said receiving antennae are connected to said amplification means. Advantageously, in this case, the amplification means are positioned in the vicinity of the receiving antennae. Therefore the amplified signal delivered to said processing calculator is of better quality.

Preferably, in order to help prevent drowning accidents, in swimming pools in particular, the processing calculator activates the warning means. Advantageously, the processing calculator can be used to estimate the quantity of air contained in the lungs of a swimmer by comparing said received electric signals received with previously measured signals.

The invention also concerns a box intended to help prevent drowning accidents. The box of the invention comprises at least one transmitting antenna and one receiving antenna of a sonar. All or part of the equipment forming the sonar is contained inside the box. The transmitting and receiving antennae have transmission and reception axes. For some variants of embodiment, they may in particular be in the form of a single antenna. The sonar is of parametric sonar type with high spatial directive gain along said transmission and/or reception axes. The angular aperture of the transmission and/or reception lobes of the transmitting and/or receiving antennae is in the order of one degree or less. The transmitting and receiving antennae are intended to deliver acoustic signals and to receive electric signals, or conversely. The electric signals are intended to be transmitted to a processing calculator, via amplification means and transmission means. The boxes are intended to be fixed to the wall or bottom of the swimming pool. A box optionally comprises swivel supports on which said transmitting and receiving antennae are mounted. For some variants of embodiment, the box is in the form of a hollow ball joint inside which said transmitting and receiving antennae are mounted. A box also optionally comprises orientation means to activate said swivel supports or said hollow ball joint and to direct said transmission or reception axes of said transmitting or receiving antennae in a particular direction in space. A box also optionally comprises modulation means to modulate the acoustic energy transmitted by said sonar. With the modulation means the acoustic energy transmitted by said sonar can be modulated by an audible low frequency signal. In particular, the low frequency signal carries a vocal message to a swimmer. A box also optionally comprises transmitting and receiving antennae such that said transmission and/or reception lobes are coaxial and directed along the transmission and reception axis of said transmitting and receiving antennae. A box also optionally comprises amplification means and/or transmission means of said electric signals towards said processing calculator.

The invention also concerns a method to help prevent drowning accidents. The method of the invention comprises the detection step to detect a swimmer and his or her position by using a parametric sonar having high spatial directive gain and whose transmission and/or reception lobes have an angular aperture in the order of one degree or less. The method of the invention optionally comprises:

the step of estimating the degree of mobility of the swimmer, and/or

the step of estimating the quantity of air remaining the lungs of said swimmer, and/or

the step of transmitting audible signals to said swimmer by means of said parametric sonar.

The invention also concerns the use of a parametric sonar, with high spatial directive gain, whose transmission and/or reception lobes have an angular aperture in the order of one degree or less, in a system for preventing drowning accidents.

Other particularities and advantages of the invention will become clearer on reading the following description given as a non-restrictive example with reference to the appended figures which show:

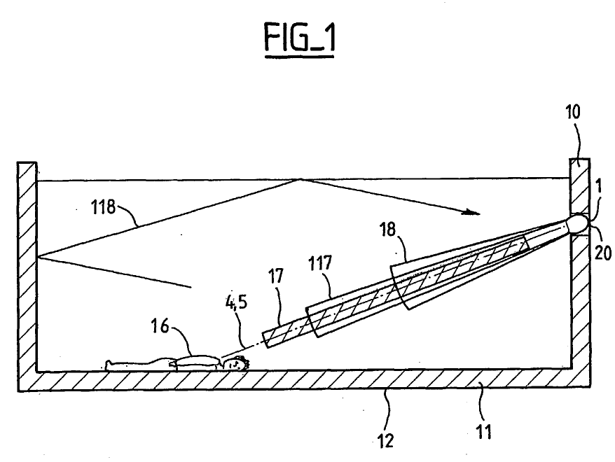

FIG. 1: a part schematic diagram of a system according to the invention showing the pattern of the primary 117 and secondary 17 transmission lobes of the transmitting antennae 2, and of the reception lobe 18 of the receiving antenna 3, and a form of embodiment of the sonar box fixed to the wall 10 of the swimming pool 12.

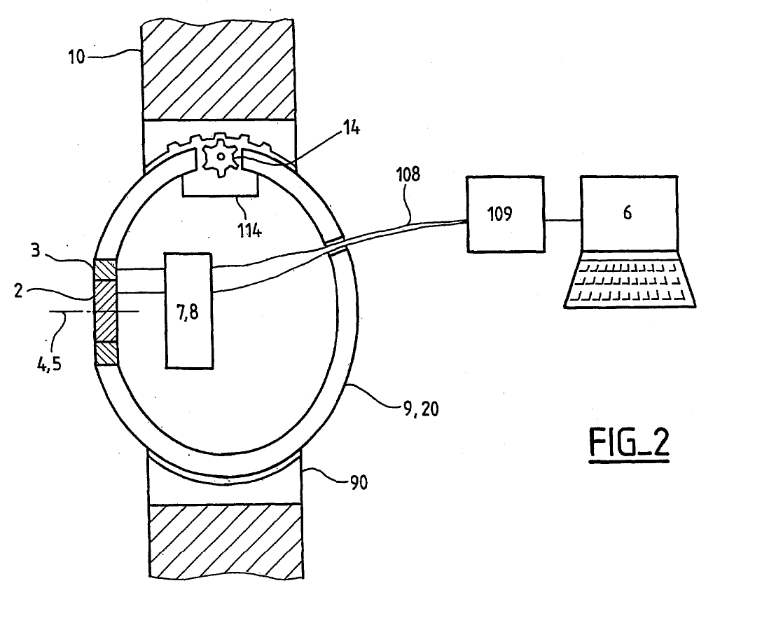

FIG. 2: schematic diagram of the principle of the system according to the invention showing the electroacoustic, electronic and mechanical sub-assemblies of the system.

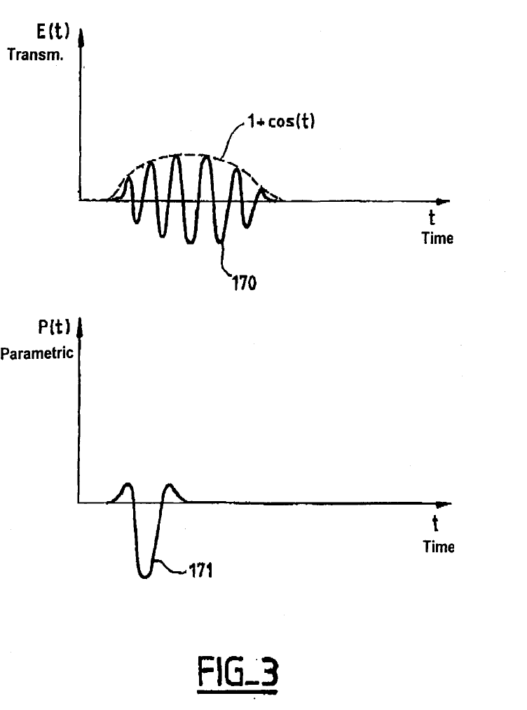

FIG. 3: a schematic diagram of the pattern of a variant of embodiment of the high frequency impulse 170 transmitted in the water and of the low frequency secondary impulse 171 it generates, after propagation, via a non-linear effect in the water.

The sonar of the invention shown in FIG. 1 comprises a transmitting antenna 2 formed of an electroacoustic transducer of diameter D and a receiving antenna 3 formed of an electroacoustic transducer. FIG. 1 shows the transmission axis 4 and reception axis 5 of said transmitting antenna 2 and receiving antenna 3. Said transmitting 2 and receiving 3 antennae may be in the form of a single antenna. The sonar 1 is of parametric sonar type with high spatial directive gain along its transmission axis 4 and/or its reception axis 5. The angular aperture of the transmission 17 and/or reception 18 lobes of the transmitting 2 and/or receiving 3 antennae is in the order of one degree or less. FIG. 1 also shows the primary 117 and secondary 17 transmission lobes of the transmitting antennae 2 and the reception lobe 18 of the receiving antenna 3, whose description will be detailed below. Said transmitting 2 and receiving 3 antennae are intended to transmit acoustic signals in the water and to receive electric signals from a processing calculator 6, or conversely. For this purpose, the sonar 1 also comprises amplification means 7 and transmission means 8 to amplify and transmit electric signals from receiving antenna 3 to the processing calculator 6. In another variant of embodiment, the sonar 1 may also comprise amplification means 7 and transmission means 8 to amplify and transmit electric signals from the processing calculator 6 to the transmitting antenna 2.

A description will now be given of how the system of the invention functions. The sonar 1 controlled by the processing calculator 6 transmits a train of high frequency impulses 170 in the water. By high frequency is meant frequencies F whose order of magnitude is 800 kHz for example. With this order of magnitude it can be guaranteed that the HF energy of the impulse train 170 in the water remains confined in a narrow primary transmission lobe 117 oriented along the transmission axis 4. The narrowness of the primary transmission lobe 117 is an important characteristic of the system of the invention: it provides better position detection of the swimmer 16 in space in particular, and better rejection of parasitic reflections 118 of the acoustic energy projected onto the surface, walls 10 and bottom 11 of the swimming pool 12.

In a far field, the angular aperture A (expressed in radians) of the transmission lobe at −3 dB from a circular transmitting antenna of diameter D (expressed in metres) at a frequency F (expressed in Hz) is given in known manner by the formula: A=c/(D.F), in which c is the velocity (expressed in m/s) of the acoustic waves in the medium under consideration. Therefore, for example, for a circular transmitting antenna of diameter D=10 cm and a frequency F=800 kHz, the angular aperture A is close to one degree.

High energy impulses are used for transmission, so that the transmitted pressure is close to the cavitation threshold. In this manner, after propagation over a distance of approximately 20 to 40 cm, via a known non-linear effect called “parametric effect”, a train of low frequency secondary impulses 171 is generated in the water, whose energy remains confined in a secondary transmission lobe 17. This secondary lobe 17 is always, in known manner, practically as narrow as the primary lobe, that is to say with an angular aperture at −3 dB that is close to one degree.

This parametric effect is described in particular in the thesis entitled “Contribution Théorique et Expérimentale à l'Etude de l'Emission et de la Réception Paramétrique” defended by Mr. Pierre Cervanka on Mar. 17, 1988 at the university Pierre et Marie Curie Paris 6 in Paris; the reference of this thesis in the INIST data base is: Th., 88 PA06 6127, Cote INIST: TD 19209. This parametric effect is also described in the following articles and publications: (a) P. J. Westervelt, “Parametric acoustic array”, JASA (Journal of the Acoustical Society of America) vol. 35 n°4, p. 535-537, 1963; (b) H. O. Berktay ‘Parametric amplification by the use of acoustic non linearities and some possible applications”, Journal of Sound and Vibrations, vol.2 n°4, p. 462, 1965; (c) M. B. Moffett and R. H. Mellen “Nearfield characteristics of parametric acoustic sources”, JASA vol. 69 n°2 p.404-409 (1981); (d) M. B. Moffett and R. H. Mellen “Effective lengths of parametric acoustic sources”, JASA vol. 70 n°5 p. 1424-1426 (1981); (e) “Nonlinear Underwater Acoustics” by B. K. Novikov, O. V. Rudenko and V. I. Timoshenko, published for the ASA (Acoustical Society of America) by the “American Institute of Physics” (1987).

The primary 170 and secondary 171 impulse trains are reflected by the different parts of the swimmer's body 16 and in particular, in prevailing manner, by the air trapped in the swimmer's lungs. It is therefore possible to detect the presence of a swimmer 16 positioned on the transmission axis 4 and reception axis 5 of sonar 1. It is also possible to determine whether this swimmer 16 has air in his/her lungs.

The energy fraction of the primary and secondary impulses reflected by the swimmer's body 16 returns to the receiving antenna 3.

The receiving antenna 3 converts the reflected acoustic energy into electric signals. These electric signals are amplified by the amplification means 7 and transmitted by the transmission means 8 via a connection cable 108 and an interface 109 to the processing calculator 6. The amplified, transmitted electric signals are digitalised and then processed by the processing calculator 6.

Advantageously, the amplification means 7 and transmission means 8 of the sonar are positioned immediately close to the receiving antenna 3. Therefore the signals delivered to the processing calculator 6 are of better quality.

Also advantageously, the amplification means 7 and transmission means 8 or amplification and transmission means of similar type, make it possible to amplify and transmit the electric signals controlled by the processing calculator 6 to transmitting antenna 2. The transmitting antenna 2 converts the electric signals into acoustic energy.

The electronic circuits and/or electroacoustic transducers and/or software used to make the amplification means 7 and transmission means 8 and the antennae 2, 3 converting the electric signals into acoustic energy and conversely, close to the cavitation threshold and producing minimum distortion, are in themselves known to persons skilled in the art.

To illustrate a variant of embodiment of the invention, it is specified that a sonar, whose circular transmitting antenna has a diameter of 10 cm, transmitting trains of impulses at the frequency of 800 kHz, has a range of over 25 metres. At this distance, the angular aperture of the transmission lobe 17, close to one degree, intercepts a circular zone whose diameter is of the order of 0.5 metre.

The electric signal received by the processing calculator 6 contains data on the distance of the swimmer 16 measured along the transmission axis 4 or reception axis 5. This distance is equal to c times the time separating the time of transmission of the impulse from the time of its reception divided by two (c being the speed of sound in the water of the swimming pool).

This electric signal also contains data on the quantity of air contained in the lungs of the swimmer 16. Preferably, to measure this quantity of air, procedure is as follows:

sonar 1 is calibrated, for any distance between 0 and the maximum range of the sonar 1, by measuring a standard signal amplitude S1 corresponding to the reflection of the impulse transmitted by a control swimmer with lungs full of air,

sonar 1 is calibrated, for any distance lying between 0 and the maximum range of sonar 1, by measuring a standard signal amplitude S2 corresponding to the reflection of the impulse transmitted by a control swimmer whose lungs contain no air,

the amplitudes S1 and S2 in relation to distance are recorded in a calibration table,

the distance of the swimmer 16 relative to the transmitting 2 and receiving 3 antennae and the amplitude of the signal reflected by the swimmer are determined simultaneously,

for the measured distance, the amplitude of the signal reflected by swimmer 16 is compared with the signal amplitudes S1 and S2 taken from the calibration table,

an estimation of the quantity of air remaining in the lungs of swimmer 16 is deduced.

This measurement, although imprecise, may be entered into the list of criteria used by the processing calculator 6 to give an alarm.

Without altering the essential technical features of the invention, the transmitted impulses may be modulated in different ways. It is possible for example as shown, and in purely illustrative non-restrictive manner, to transmit a high frequency impulse 170 made up of a certain number of sinusoidal waves whose envelope is modulated in 1+cos( ) . In the case of this particular modulation, the pattern of the secondary impulse 171 obtained by parametric effect after propagation in water over a certain distance is shown in FIG. 3.

The repetition frequency of impulses 170 and 171 is the highest possible. This high repetition frequency can be used to measure the successive positions of the swimmer 16 along reception axis 5 and to deduce therefrom, with accuracy, the vector component of the swimmer's speed of movement along said direction. This measurement of speed of movement provides another indication on the condition of swimmer 16: no movement possibly being considered as a sign of an abnormal situation.

One variant of the invention consists of using several sonars 1 placed at different points of the swimming pool 12. It is therefore possible to determine the position of swimmer 16 with even further accuracy using triangulation in particular. It is therefore also possible to measure simultaneously the components of the speed vector of swimmer 16 along several reception axes 5. If at least three receiving antennae 3 are used, it is possible to reconstitute the speed vector of swimmer 16 using processed data. With the system of the invention, it is therefore also possible to produce a tomogram of all or part of the submerged area of the swimming pool 12 by systematic scanning in a plurality of directions. The volume of water of the swimming pool 12 is divided into directive exploration sections. Each exploration section is shown along a plane by the processing calculator 6 by accumulating and juxtapositioning the sonar information obtained by scanning.

This tomographic image simplifies monitoring by the pool supervisor of the submerged area of the swimming pool 12.

In one particular functioning mode of the system of the invention, the repetition frequency of impulses 170, 171 may be modulated by an audible signal, for example a vocal signal requesting the swimmer 16 to resurface. Since the energy of impulses 170, 171 is contained in a transmission lobe 117, 17 of small angular aperture, the message is better heard by the swimmer 16 positioned in the transmission lobe 117, 17 than by other swimmers positioned outside these lobes and at the same distance from the transmitting antenna 2 as the swimmer 16. The directive nature of transmission makes it possible to send a message that is more audible for the swimmer 16 in difficulty or by a nearby swimmer who could provide assistance.

In one variant of embodiment using optical cameras to monitor the swimming pool, the system of the invention is used to provide additional criteria for the assessment of a swimmer's condition and to remove any doubt.

According to one variant of embodiment of the system of the invention, the transmitting 2 and receiving 3 antennae are made such that their transmission axis 4 and reception axis 5 coincide. Therefore the sighting axis of sonar 1 is both the transmission axis 4 and the reception axis 5.

A variant of embodiment will now be described of the electromechanical assembly in which all or part of sonar is mounted. This electromechanical assembly is made up of a box 9 fixed to the wall or bottom of the swimming pool 12, a transmitting antenna 2, a receiving antenna 3. In the variant of embodiment shown in FIG. 1, the box 9 is in the shape of a hollow ball joint 20, that can be rotated, mounted mobile fashion in a housing 90 made in wall 10 or bottom 11 of the swimming pool 12. This ball joint 20 is activated by orientation means 14 driven by a motor 114. In this variant of embodiment, the transmitting antenna 2 and receiving antenna 3 are mounted inside the hollow ball joint 20. It is therefore possible to direct the transmission axis 4 and reception axis 5 in a determined direction in space, in particular in the direction in which it is sought to detect a swimmer, much like an eye moving within its orbit. The diameter D of the transmission electroacoustic transducer is chosen so as to facilitate its installation in the thickness of walls 10, 11 of the swimming pool 12. In the described variant of embodiment, diameter D is of the order of 10 centimetres.

In the case of another variant of embodiment that is not shown, the transmitting antenna 2 and receiving antenna 3 are mounted on swivel supports 13 which are themselves mounted mobile fashion inside box 9. As in the case of the preceding variant, these swivel supports are activated by orientation means 14 driven by a motor 114. In this variant of embodiment, the box 9 is fixed inside a housing 90 made in the wall 10 or bottom 11 of the swimming pool 12.

Advantageously, for these two variants of embodiment, the amplification means 7 and transmission means 8 and the orientation means 14 and motor 114 are contained in box 9 or ball joint 20.

For these variants of embodiment, the transmitting 2 and receiving 3 antennae may be orientated such that they automatically scan the submerged area of the swimming pool 12. It is therefore possible, with a limited number of sonars 1, to produce a tomographic image of all or part of said submerged area, in the same way as previously described using a plurality of sonars 1 arranged at different points of the swimming pool 12.

1. Warning system to help prevent drowning accidents; said system comprising at least one sonar (1), each sonar (1) comprising:
at least one transmitting antenna (2) and one receiving antenna (3) having transmission (4) and reception (5) axes; said transmitting (2) and receiving (3) antennae possibly being in the form of a single antenna; said sonar (1) being of parametric sonar type with high spatial directive gain along said transmission axis (4) and/or reception axis (5); the angular aperture of the transmission lobes (17) and/or reception lobes (18) of said transmitting antenna (2) or receiving antenna (3) being in the order of one degree or less; said transmitting (2) and receiving (3) antennae being intended to deliver acoustic signals and to receive electric signals or conversely; said system also comprising:
a processing calculator (6), said sonar (1) also comprising:
amplification means (7) and transmission means (8) to amplify and transmit, to said processing calculator (6), said electric signals derived from said receiving antenna (3), and/or
amplification means (7) and transmission means (8) to amplify and transmit, to said transmitting antenna (2), the electric signals derived from said processing calculator (6).

2. System according to claim 1; said system also comprising boxes (9); each box (9) being fixed to the wall (10) or bottom (11) of the swimming pool (12); said transmitting (2) and receiving (3) antennae being mounted inside said boxes (9) on swivel supports (13), in particular inside boxes (9) in the form of ball joints (20); each box (9) also comprising orientation means (14) to activate said swivel supports (13) and to direct said transmission axis (4) and/or reception axis (5) of said transmitting antenna (2) and receiving antenna (3) along a particular direction in space.

3. System according to either of claims 1 or 2; said system comprising modulation means (15) to modulate the acoustic energy transmitted by said sonar (1); said modulation means (15) making it possible, by an audible low frequency signal, to modulate the acoustic energy transmitted by said sonar (1); said low frequency signal carrying in particular a vocal message to a swimmer (16).

4. System according to either of claims 2 or 3, said system being such that said transmission lobes (17) and/or reception lobes (18) are coaxial and directed along a transmission axis (4) and reception axis (5) of said transmitting (2) and receiving (3) antennae,
(so that said orientation means (14) can be used to orientate simultaneously the transmission axis (4) and reception axis (5) of said transmitting (2) and receiving (3) antennae).

5. System according to any of claims 1 to 4; said system being such that said receiving antennae (3) are connected to said amplification means (7) ; said amplification means (7) being positioned close to said receiving antennae (3),
(so that the amplified signal delivered to said processing calculator (6) is of better quality).

6. System according to any of claims 1 to 5; said processing calculator (6) activating the warning means (19).

7. System according to any of claims 1 to 6; said processing calculator (6) being used to estimate the quantity of air contained in the lungs of a swimmer (16) by comparing said received electric signals with previously measured signals.

8. Box (9) intended to help prevent drowning accidents: said box (9) comprising at least one transmitting antenna (2) and one receiving antenna (3) of a sonar (1); said transmitting (2) and receiving (3) antennae having a transmission axis (4) and a reception axis (5) and possibly being in the form of a single antenna; said sonar (1) being of parametric sonar (1) type having high spatial directive gain along said transmission axis (4) and/or reception axis (5); the angular aperture of the transmission lobes (17) and/or reception lobes (18) of said transmitting (2) and/or receiving (3) antennae being in the order of one degree or less; said transmitting (2) and receiving (3) antennae being intended to deliver acoustic signals and to receive electric signals or conversely; said electric signals being intended to be transmitted to a processing calculator (6) via amplification means (7) and transmission means (8); said boxes being intended to be fixed to the wall (10) or bottom (11) of the swimming pool (12);
said box (9) optionally comprising:
swivel supports (13) on which said transmitting and receiving antennae are mounted, and/or being in the form of a hollow ball joint (20) inside which said transmitting (2) and receiving (30) antennae are mounted, and/or
orientation means (14) to activate said swivel supports (13) or said hollow ball joint (20) and to direct said transmission axis (4) or reception axis (5) of said transmitting (2) and receiving (3) antennae in a particular direction in space, and/or
modulation means (15) to modulate the acoustic energy transmitted by said sonar (1); said modulation means (15) being used, by an audible low frequency signal, to modulate the acoustic energy transmitted by said sonar (1); said low frequency signal particularly carrying a vocal message to a swimmer (16), and/or
transmitting (2) and receiving (3) antennae such that said transmission lobes (17) and/or reception lobes (18) are coaxial and directed along the transmission axis (4) and reception axis (5) of said transmitting (2) and receiving (3) antennae, and/or
amplification means (7) and/or transmission means (8) for said electric signals towards said processing calculator (6).

9. Method to help prevent drowning accidents, said method comprising the step for detecting a swimmer (16) and his/her position by using a parametric sonar (1) having high spatial directive gain, whose transmission lobes (17) and/or reception lobes (18) have an angular aperture in the order of one degree or less;
said method optionally comprising:
the step of estimating the extent of mobility of the swimmer (16), and/or
the step of estimating the quantity of air remaining in the lungs of said swimmer (16), and/or
the step of transmitting audible signals to said swimmer (16) by means of said parametric sonar (1).

10. Use of a parametric sonar (1), having high spatial directive gain whose transmission lobes (17) and/or reception lobes (18) have an angular aperture of one degree or less, in system for preventing drowning accidents.
